(19) United States
(12) Patent Application Publication
(10) Pub. No.: US 2025/0364695 A1
(43) Pub. Date: Nov. 27, 2025

(54) BUSBAR MODULE AND BATTERY PACK

(71) Applicants: DENSO CORPORATION, Kariya-city (JP); YAZAKI CORPORATION, Tokyo (JP)

(72) Inventors: Nakae YUZAWA, Kariya-city (JP); Ryosuke OSAKA, Makinohara-shi (JP); Takahiro MOCHIZUKI, Makinohara-shi (JP)

(73) Assignees: DENSO CORPORATION, Kariya-city (JP); YAZAKI CORPORATION, Tokyo (JP)

(21) Appl. No.: 19/297,759

(22) Filed: Aug. 12, 2025

Related U.S. Application Data
(63) Continuation of application No. PCT/JP2023/045312, filed on Dec. 18, 2023.

(30) Foreign Application Priority Data
Feb. 16, 2023 (JP) 2023-022497

(51) Int. Cl. H01M 50/503; H01M 50/209; H01M 50/507

(52) U.S. Cl. CPC H01M 50/503; H01M 50/209; H01M 50/507

(57) ABSTRACT

A busbar module is provided on electrode surfaces of battery cells stacked in a thickness direction. The busbar module includes a substrate and a busbar that has a busbar main body connected to electrode terminals of the battery cells. A connecting piece extends from the busbar main body to overlap with the substrate, and is connected to the substrate. Solder fixes the substrate and the connecting piece. A guide structure is provided on the connecting piece, having a guide surface for guiding the solder. The solder adheres to the guide surface and at least a portion of a continuous surface forming an outer shell of the connecting piece and is continuous with the guide surface.

### CROSS REFERENCE TO RELATED APPLICATIONS

The present application is a continuation application of International Patent Application No. PCT/JP2023/045312 filed on Dec. 18, 2023, which designated the U.S. and claims the benefit of priority from Japanese Patent Application No. 2023-022497 filed on Feb. 16, 2023. The entire disclosures of all of the above applications are incorporated herein by reference.

### TECHNICAL FIELD

The present disclosure relates to a busbar module and a battery pack.

### BACKGROUND

A battery assembly is attached to a busbar module.

### SUMMARY

According to at least one embodiment, a busbar module is provided on electrode surfaces of battery cells stacked in a thickness direction. The busbar module includes a substrate and a busbar that has a busbar main body connected to electrode terminals of the battery cells. A connecting piece extends from the busbar main body to overlap with the substrate, and is connected to the substrate. Solder fixes the substrate and the connecting piece. A guide structure may be provided on the connecting piece, having a guide surface for guiding the solder. The solder may adhere to the guide surface and at least a portion of a continuous surface forming an outer shell of the connecting piece and is continuous with the guide surface. The busbar module may be included in a battery pack.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an exploded perspective view of a battery pack.

FIG. 2 is a perspective view of the battery pack with a case removed.

FIG. 3 is a perspective view of a busbar module with a holder removed.

FIG. 4 is a perspective view illustrating a connection relationship between a terminal and a connecting piece.

FIG. 5 is an enlarged view of a connection point between the terminal and the connecting piece.

FIG. 6 is a schematic diagram illustrating one of guide structures of a first embodiment.

FIG. 7 is a schematic diagram illustrating another guide structure in the first embodiment.

FIG. 8 is a schematic diagram illustrating a guide structure in a second embodiment.

FIG. 9 is a cross-sectional view illustrating the guide structure of the second embodiment.

FIG. 10 is a cross-sectional view illustrating a modification of the guide structure of the second embodiment.

FIG. 11 is a schematic diagram illustrating a guide structure in a third embodiment.

FIG. 12 is a cross-sectional view illustrating the guide structure of the third embodiment.

FIG. 13 is a schematic diagram illustrating a guide structure of a fourth embodiment.

FIG. 14 is a cross-sectional view illustrating the guide structure of the fourth embodiment.

### DETAILED DESCRIPTION

To begin with, examples of relevant techniques will be described.

A battery assembly according to a comparative example is attached to a busbar module. The battery assembly is arranged such that positive and negative electrodes of individual cells are alternately stacked. The busbar module has a flexible substrate and includes a circuit body with busbars attached, which are connected to the positive and negative electrodes of the individual cells. The circuit body includes a main line arranged along a stacking direction on each individual cell, and a strip-shaped first branch line extending in a direction intersecting a longitudinal direction and a thickness direction of the main line. At the end of the first branch line, a strip-shaped second branch line extending in a direction parallel to the stacking direction of each battery body is provided. On the second branch line, a connector piece protruding from the busbar to the main line is attached.

A connecting piece is fixed to a connecting portion at a tip of the second branch line via solder. The solder is provided at a boundary between the connecting portion of the second branch line and the connecting piece. The solder adheres to an outer surface of the connecting piece along an edge of the connecting piece. Due to an insufficient amount of solder adhering to the connecting piece, when stress is applied to the solder, there is a risk that the solder will be damaged due to insufficient strength, potentially resulting in an inability to maintain connection between the connecting piece and the connecting portion.

In contrast to the comparative example, according to a busbar module and a battery pack of the present disclosure, connection between a substrate and a connecting piece is likely to be maintained even when stress is applied to solder.

According to one aspect of the present disclosure, a busbar module is provided on electrode surfaces of battery cells stacked in a thickness direction. The busbar module includes a substrate and a busbar that has a busbar main body connected to electrode terminals of the battery cells. A connecting piece extends from the busbar main body to overlap with the substrate, and is connected to the substrate. Solder fixes the substrate and the connecting piece. A guide structure is provided on the connecting piece, having a guide surface for guiding the solder. The solder adheres to the guide surface and at least a portion of a continuous surface forming an outer shell of the connecting piece and is continuous with the guide surface.

According to this configuration, since the solder adheres to both at least a part of the continuous surface and the guide surface, an amount of solder adhering to the connecting piece increases. As a result, a connection between the substrate and the connecting piece becomes stronger. Even if stress is applied to the solder, the connection between the substrate and the connecting piece is easily maintained.

According to another aspect of the present disclosure, a battery pack includes battery cells stacked in a thickness direction and a busbar module provided on electrode surfaces of the battery cells. The busbar module includes a substrate and a busbar with a busbar main body connected to electrode terminals of the battery cells. A connecting piece extends from the busbar main body to overlap with the substrate and is connected to the substrate. Solder fixes the substrate and the connecting piece. A guide structure is provided on the connecting piece, having a guide surface for guiding the solder. The solder adheres to the guide surface and at least a portion of a continuous surface forming an outer shell of the connecting piece and is continuous with the guide surface.

According to this configuration, the battery pack includes the busbar module. Since the solder adheres to both at least a part of the continuous surface and the guide surface, an amount of solder adhering to the connecting piece increases. As a result, a connection between the substrate and the connecting piece becomes stronger. Even if stress is applied to the solder, the connection between the substrate and the connecting piece is easily maintained.

The following describe embodiments for carrying out the present disclosure with reference to the drawings. In each embodiment, parts corresponding to the elements described in the preceding embodiments are denoted by the same reference numerals, and redundant explanation may be omitted. When only a part of the configuration is described in each embodiment, another embodiment described previously may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

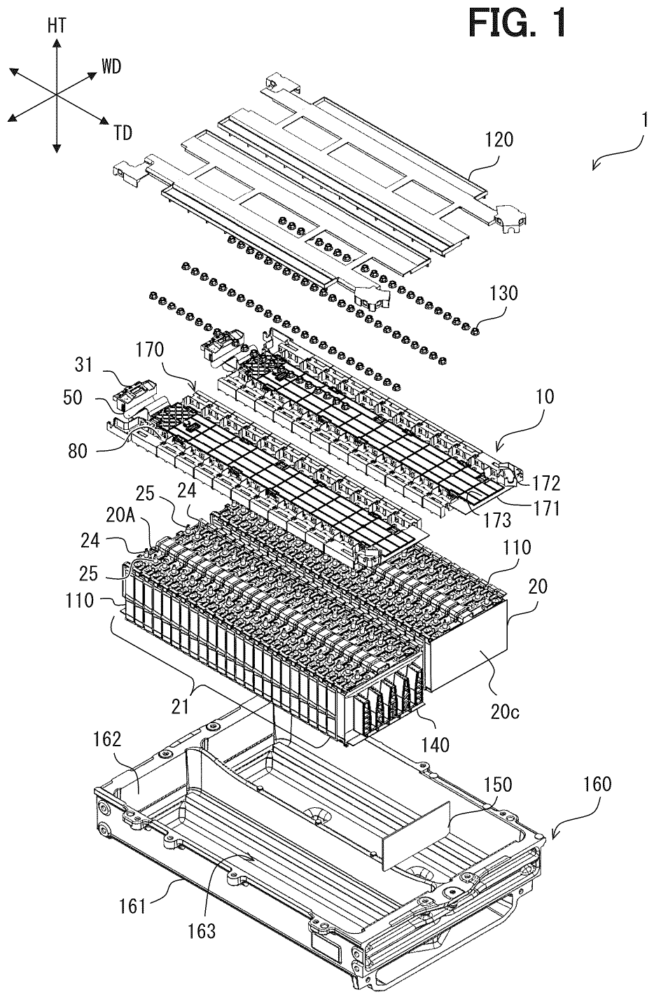

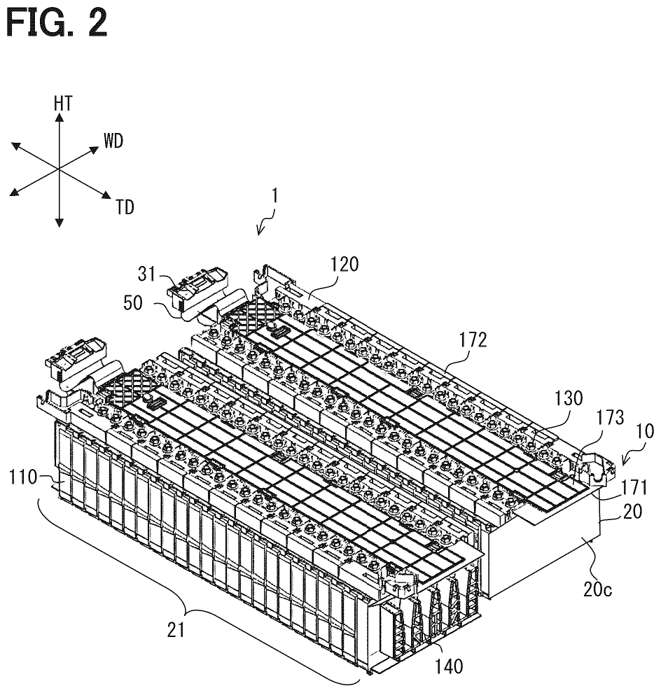

A battery pack 1 and a busbar module 10 will be described with reference to FIGS. 1 to 7. FIG. 1 schematically illustrates various components of the battery pack 1. FIGS. 2 to 7 schematically illustrate various components of the busbar module 10. The battery pack 1 of a first embodiment is applied to electric vehicles such as electric cars and plug-in hybrid vehicles as an example. The battery pack 1 includes battery cells 20. The battery cells 20 are secondary batteries. Secondary batteries that can be used for the battery cells 20 include, for example, lithium-ion secondary batteries, nickel-metal hydride secondary batteries, and organic radical batteries. The secondary batteries generate electric voltage by chemical reaction.

In the following description, a thickness direction of the battery cells 20 may be referred to as a thickness direction TD. The thickness direction TD corresponds to a stacking direction of battery assemblies 21. A width direction of the battery cells 20 may be referred to as a width direction WD. An up-down direction of the battery cells 20 may be referred to as an up-down direction HT. The thickness direction TD, the width direction WD, and the up-down direction HT are mutually orthogonal. In the drawings, the thickness direction TD may simply be indicated as “TD”. The width direction WD may simply be indicated as “WD”. The up-down direction HT may simply be indicated as “HD”.

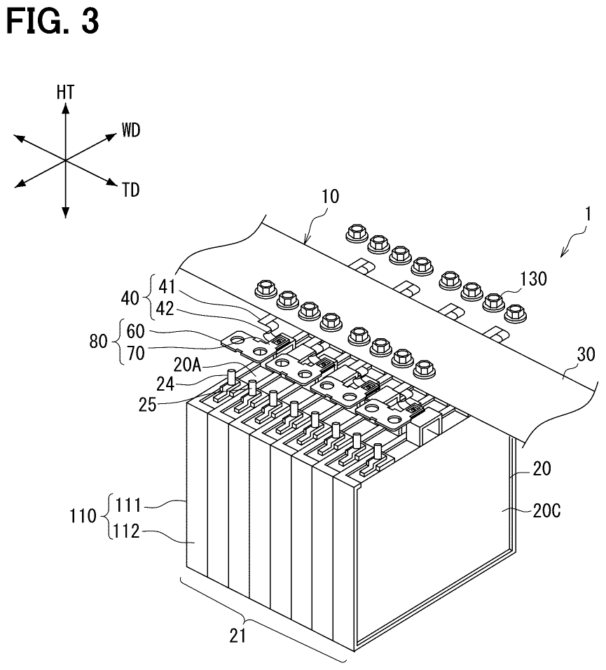

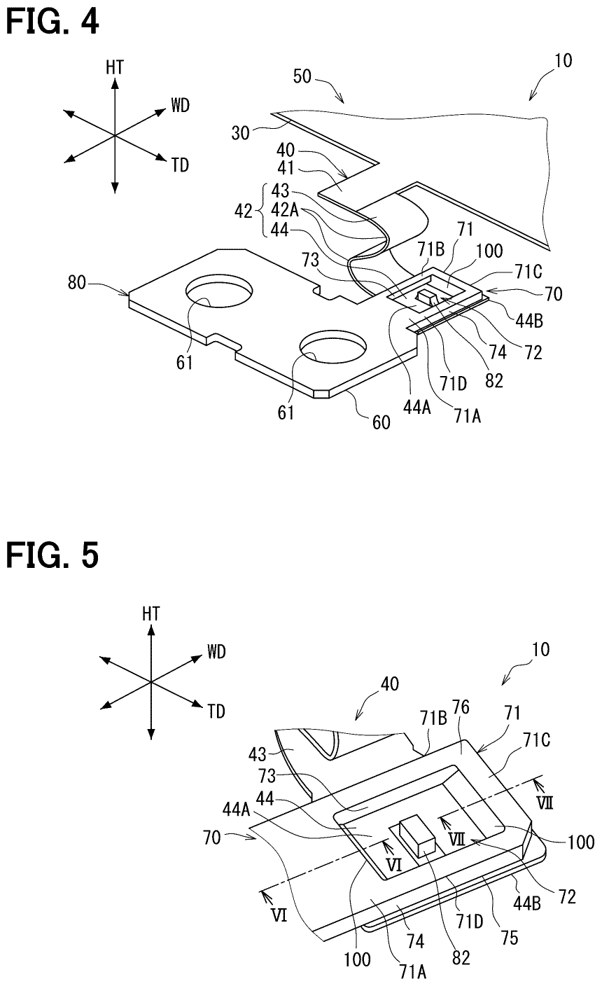

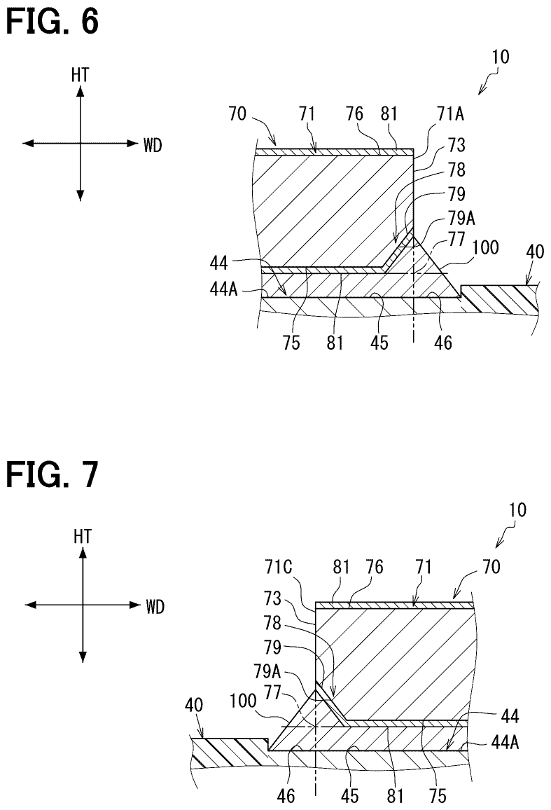

Next, drawings will be explained. FIG. 1 is an exploded perspective view of the battery pack 1. FIG. 2 is a perspective view of the battery pack 1 with a case 160 removed. FIG. 3 is a perspective view of a busbar module with a holder removed. FIG. 4 is a perspective view illustrating a connection relationship between a terminal 40 and a connecting piece 70. FIG. 5 is an enlarged view of a connection point between the terminal 40 and the connecting piece 70. FIG. 6 is a schematic diagram illustrating one of guide structures 78 of the first embodiment. FIG. 7 is a schematic diagram illustrating another guide structure 78 in the first embodiment.

### <In-Vehicle Battery>

The battery pack 1 is mounted in an electric vehicle and constitutes an in-vehicle power supply. The in-vehicle power supply functions to provide electric power to vehicle's electrical loads. As a place for disposing the in-vehicle power source, for example, space below a front seat of the vehicle, space below a backseat, space between a backseat and a trunk, or the like can be properly employed.

The battery pack 1 has the busbar module 10, the battery cells 20, a resin frame 110, a cover 120, nuts 130, end plates 140, shims 150, and a case 160 that houses these components. Firstly, the case 160 will be described.

### <Case>

The case 160 has a bottomed box shape formed by die casting, as an example. Materials such as aluminum are used for the case 160. The case 160 has a bottom wall 161 and side walls 162. The bottom wall 161 and the side walls 162 are integrally connected. The bottom wall 161 has a flat shape with a thin thickness in the up-down direction HT. The side walls 162 stand upright in the up-down direction HT from an inner bottom surface of the bottom wall 161. The side walls 162 extend along an edge of the inner bottom surface and form an annular shape in a circumferential direction around the up-down direction HT. A storage space 163 of the case 160 is formed by the bottom wall 161 and the side walls 162.

The battery cells 20 are housed in the storage space 163. The battery cells 20 are arranged and stored in two rows in the width direction WD within the storage space 163. The case 160 has an opening at one end in the up-down direction HT. The battery cells 20 are housed in the case 160 such that electrode surfaces 20A of each battery cell 20 correspond to the opening side. Each battery cell 20 is stacked such that main surfaces 20C overlap each other in the thickness direction TD.

### <Battery Cell>

The battery cell 20 has a substantially rectangular parallelepiped shape with a thin thickness in the thickness direction TD. A battery cell 20 includes an electrode surface 20A having a positive terminal 24 and a negative terminal 25, and two main surfaces 20C along planes orthogonal to the thickness direction TD. The electrode surface 20A is provided between the two main surfaces 20C so as to connect the two main surfaces 20C. The battery cell 20 has a positive electrode and a negative electrode at both ends in the width direction WD of the electrode surface 20A. The battery cells 20 are stacked in the thickness direction TD such that the positive and negative electrodes are alternately arranged with respect to the thickness direction TD.

### <Resin Frame>

The resin frame 110 is disposed between each of the adjacent battery cells 20 in the stack of battery cells 20. The battery cells 20 and resin frames 110 are alternately arranged with respect to the stacking direction. A battery assembly 21 is formed by alternately stacking and arranging the battery cells 20 and the resin frames 110. The resin frame 110 is formed of a resin material that has electrical insulation properties, for example. The resin frame 110 is arranged as an insulating member between adjacent battery cells 20.

The resin frame 110 includes a central body 111 that faces the main surface 20C of the battery cell 20, and a frame body 112 that is integrally connected to the periphery of the central body 111 and provided in an annular shape. The battery cell 20 is housed in a space defined by the central body 111 and the frame body 112, and its position is fixed. A positive terminal 24 electrically connected to the positive electrode and a negative terminal 25 electrically connected to the negative electrode are provided on a wall of the frame body 112 that faces the electrode surface 20A. In addition, the positive terminal 24 and the negative terminal 25 may collectively be referred to as electrode terminals 24, 25.

### <End Plate and Shim>

As shown in FIG. 1, an end plate 140 is attached from an outside to the battery cell 20 located at an end in the thickness direction TD, so as to cover the battery cell 20. The end plate 140 is composed of a resin member having electrical insulating properties, as an example. Furthermore, a shim 150 is provided between the end plate 140 and the side walls 162 to adjust a relative positions of each component. The shim 150 is composed of a metal member, as an example.

### <Busbar Module>

The busbar module 10 is positioned above the battery assembly 21 so as to cover the electrode surfaces 20A of the battery cells 20. The busbar module 10 includes a substrate 50, a busbar 80, solder 100, and a holder 170. The substrate 50 is electrically connected to the electrode terminals 24 and 25 of the battery cells 20 via the busbar 80. The substrate 50 and the busbar 80 are held and housed within the holder 170. The substrate 50 is a flexibly deformable flexible substrate. A wiring pattern is provided on the substrate 50. On front and back surfaces of the substrate 50, resin layers covering the wiring pattern are provided.

### <Substrate>

The substrate 50 has a base 30 and terminals 40. The base 30 is provided above the battery assembly 21 so as to cover an area between the positive terminal 24 and the negative terminal 25, which are arranged side by side in the width direction WD. The base 30 extends in the thickness direction TD. The electrode terminals 24 and 25 are provided outside in the width direction WD relative to the base 30. The base 30 and the electrode terminals 24 and 25 are arranged side by side, spaced apart in the width direction WD. A voltage detection line for detecting voltage of the battery cell 20 is provided on the base 30.

### <Terminal>

The terminals 40 are provided at both ends in the width direction WD of the base 30. A terminal 40 has a first extension portion 41 and a second extension portion 42. The first extension portion 41 extends in the width direction WD from the end of the base 30 in the width direction WD toward each of the electrode terminals 24, 25. The second extension portion 42 is provided at an end of the first extension portion 41 that is farther from the base 30. The second extension portion 42 is provided at an edge in the width direction WD at the end of the first extension portion 41 that is farther from the base 30.

The second extension portion 42 extends away from the first extension portion 41 and toward the electrode surface 20A. It can also be said that the second extension portion 42 extends in the up-down direction HT toward the electrode surface 20A. The base 30 is provided above the electrode surface 20A by approximately a length of the second extension portion 42 in the up-down direction HT. The second extension portion 42 is bent in a substantially S-shape while extending in the up-down direction HT toward the electrode surface 20A. It can also be said that the second extension portion 42 has two bent portions 42A that bend in opposite directions. The two bent portions 42A are arranged consecutively in the up-down direction HT. One of the two bent portions 42A is bent in a peak shape, while the other one of the two bent portions 42A is bent in a valley shape.

As described above, the substrate 50 is a flexible substrate. Therefore, the base 30, the first extension portion 41, and the second extension portion 42 are flexibly deformable. The base 30 and the first extension portion 41 are particularly flexible and deformable in the up-down direction HT. The second extension portion 42 is particularly flexible and deformable in the up-down direction HT and the thickness direction TD. As shown in FIG. 3, a distal end of the second extension portion 42, which is distant from the first extension portion 41, extends in the thickness direction TD. It can also be said that the distal end of the second extension portion 42, which is distant from the first extension portion 41, has a length in the thickness direction TD. It can also be said that the second extension portion 42 has a shaft portion 43 that extends in the up-down direction HT away from the first extension portion 41, and a tip portion 44 that extends in the thickness direction TD from a distal end of the shaft portion 43, which is distant from the first extension portion 41.

### <Tip Portion>

The tip portion 44 has a thin plate-like shape in the up-down direction HT. The tip portion 44 is provided between the base 30 and the battery assembly 21 in the up-down direction HT. The tip portion 44 is provided above the electrode surface 20A in the up-down direction HT. The tip portion 44 is a portion that is electrically connected to the electrode terminals 24 and 25 via the busbar 80. The tip portion 44 has a front surface 44A located on the base 30 side and a rear surface 44B on the opposite side. The front surface 44A is a surface to which the busbar 80 is connected. The front surface 44A extends flatly along a plane that is orthogonal to the up-down direction HT. By connecting a connecting piece 70 of the busbar 80 to the front surface 44A, the voltage detection wiring provided on the base 30 is electrically connected to the electrode terminals 24 and 25.

Additionally, a connector 31 is attached to an end of the base 30. The connector 31 is connected to the voltage detection line and can be connected to an external voltage detection device. Electric current flows through the voltage detection line when the tip portion 44 is electrically connected to the electrode terminals 24 and 25 via the busbar 80. The electric current that flows through the voltage detection line passes through the connector 31 and flows to the external voltage detection device. The voltage detection device detects the voltage of the battery cell 20 based on this electric current.

### <Busbar>

The busbar 80 is a flat, metal plate-like member in the up-down direction HT. As an example, the busbar 80 is primarily made of copper. The busbar 80 includes a busbar main body 60 and the connecting piece 70 that protrudes from the busbar main body 60. The busbar 80 is provided above the battery cell 20 so as to overlap with the electrode surface 20A. The busbar main body 60 is a part that is electrically connected to the electrode terminals 24 and 25. The connecting piece 70 extends in the width direction WD from the busbar main body 60 towards the tip portion 44. The connecting piece 70 is a part that is electrically connected to the tip portion 44. The connecting piece 70 may be separate from the busbar main body 60.

The busbar main body 60 has two through holes 61 through which the positive terminal 24 and the negative terminal 25, adjacent in the thickness direction TD, pass. The positive terminal 24 and the negative terminal 25 pass through the two through holes 61. From above the busbar main body 60, nuts 130 are threaded onto the positive terminal 24 and the negative terminal 25. The nuts 130 are secured to the positive terminal 24 and the negative terminal 25. As a result, the electrode terminals 24 and 25 are electrically and mechanically connected to the busbar main body 60.

As described above, the terminals 40 are provided at the ends of the base 30 in the width direction WD. The busbar 80 is provided outside the terminals 40 in the width direction WD. The terminal 40 includes the first extension portion 41 extending in the width direction WD from the end of the base 30 in the width direction WD, and the second extension portion 42 extending in the up-down direction HT from the end of the first extension portion 41. The second extension portion 42 has the shaft portion 43 that extends in the up-down direction HT away from the first extension portion 41, and the tip portion 44 that extends in the thickness direction TD from the distal end of the shaft portion 43, which is distant from the first extension portion 41. The busbar main body 60 of the busbar 80 is provided on the electrode terminals 24 and 25. The connecting piece 70 of the busbar 80 extends in the width direction WD from the busbar main body 60 toward the tip portion 44. The connecting piece 70 is connected to the tip portion 44 via the solder 100.

### <Holder>

The holder 170 is a holding and storing structure for holding and storing the substrate 50 and the busbar 80. The holder 170 is made of, for example, a resin with electrical insulating properties. The holder 170 includes a main-body storage portion 171, terminal storage portions 172, and a lid 173. The main-body storage portion 171 is provided on the battery cell 20 side relative to the base 30. The main-body storage portion 171 holds the base 30 from below. The terminal storage portions 172 are provided at both ends in the width direction WD of the main-body storage portion 171. The terminal 40 is held and stored in the terminal storage portions 172. The terminal 40 is exposed from the terminal storage portions 172. The substrate 50 is covered on the opposite side of the main-body storage portion 171 by the lid 173 that made of a resin and has electrical insulation properties.

### <Cover and Nut>

Additionally, a resin cover 120 with electrical insulation properties is assembled to the holder 170. The cover 120 is assembled from above the holder 170 to protect live parts from external contact. By attaching the cover 120 to the holder 170 in this manner, a connection area between the tip portion 44 and the connecting piece 70 is protected from external moisture and dust.

### <Connecting Piece>

The connecting piece 70 has a frame shape forming an annular configuration around the up-down direction HT. The connecting piece 70 has a roughly rectangular shape when viewed from the up-down direction HT. The connecting piece 70 has four edge 71 that form a frame. Hereinafter, an edge 71 that extends continuously from the busbar main body 60 may be referred to as a first edge 71A. An edge 71 that is provided to face the first edge 71A may be referred to as a third edge 71C. An edge 71 that connects one end of the first edge 71A and one end of the third edge 71C may be referred to as a second edge 71B. An edge 71 that connects the other end of the first edge 71A and the other end of the third edge 71C may be referred to as a fourth edge 71D. The first edge 71A, the second edge 71B, the third edge 71C, and the fourth edge 71D are provided in this order in a clockwise direction on the busbar main body 60. A space 72 is defined by the four edges 71. It can also be said that the space 72 is defined by an inner surfaces 73 of the four edges 71. The battery pack 1 also further includes a chip fuse 82. The chip fuse 82 is located in the space 72. Details are omitted, but a wiring such as the voltage detection wiring provided on the base 30 and the connecting piece 70 are electrically connected via the chip fuse 82.

The four edges 71, in addition to the inner surfaces 73, have outer surfaces 74, opposing surfaces 75, and upper surfaces 76. In other words, the connecting piece 70 has the inner surfaces 73, the outer surfaces 74, the opposing surfaces 75, and the upper surfaces 76. The outer surface 74 is a surface provided outward from the inner surface 73 in a direction perpendicular to the up-down direction HT. The opposing surface 75 is a surface that faces a surface 44A of the tip portion 44. The opposing surface 75 is a surface that connects one end of the inner surface 73 in the up-down direction HT to one end of the outer surface 74 in the up-down direction HT. The opposing surface 75 is a surface that maintains a constant separation distance from the surface 44A and is spaced apart from the surface 44A in the up-down direction HT. The upper surface 76 is a surface that connects the other end of the inner surface 73 in the up-down direction HT to the other end of the outer surface 74 in the up-down direction HT. It should be noted that the outer surface 74 of the first edge 71A is integrally connected to the busbar main body 60.

The connecting piece 70 is provided at the tip portion 44 such that the opposing surfaces 75 of the four edges 71 overlap the surface 44A in the up-down direction HT. The solder 100 is provided between the edges 71 and the tip portion 44. The connecting piece 70 and the tip portion 44 are fixed via the solder 100. Since the surface 44A at the tip portion 44 is a portion where the solder 100 is connected, it may also be referred to as a solder connecting portion. Furthermore, at the solder connecting portion, in an overlapping region 45 where the first edge 71A and the third edge 71C overlap, and in a continuous region 46 that extends slightly from the overlapping region 45 towards a space 72 side, a resin layer is removed.

The solder 100 is provided in the overlapping region 45, which overlaps with the first edge 71A and the third edge 71C, and in the continuous region 46, which extends slightly from this overlapping region 45 towards the space 72 side. By the solder 100 provided in the overlapping region 45, which overlaps with the first edge 71A, and the continuous region 46 extending from this overlapping region 45, the first edge 71A and the tip portion 44 are electrically connected and fixed. By the solder 100 provided in the overlapping region 45, which overlaps with the third edge 71C, and the continuous region 46 extending from this overlapping region 45, the third edge 71C and the tip portion 44 are electrically connected and fixed.

As described above, the first edge 71A and the third edge 71C are arranged side by side, spaced apart in the width direction WD. Therefore, it can be said that the connecting piece 70 and the tip portion 44 are fixed by the solder 100 at two locations spaced apart in the width direction WD. Alternatively, since the solder 100 is provided in the continuous region 46, it can be said that the solder 100 is provided in a region outside a projection area of the surface 44A on the edge 71. Therefore, the solder 100 is visible when viewed in the up-down direction HT.

### <Guide Structure>

Furthermore, on an inner side of the edge 71, which is the space 72 side, there is provided a guide structure 78 having a guide surface 79A that guides the solder 100. The guide structure 78 is a structure having the guide surface 79A that connects to the opposing surface 75 and the inner surface 73. The guide structure 78 is an inclined portion 79, which includes an inclined surface as the guide surface 79A, connecting the opposing surface 75 and the inner surface 73. It should be noted that the guide structure 78 is not limited to the inclined portion 79. It should be noted that, as will be explained later, the guide structure 78 may also be a recessed portion 279 that is recessed from the opposing surface 75, a recessed portion 379 that is recessed from the inner surface 73, or a curved portion 479 that includes a curved surface connecting the opposing surface 75 and the inner surface 73.

The inclined portion 79 is an incline where the guide surface 79A extends away from the surface 44A, which is the solder connecting portion of the tip portion 44. The inclined portion 79 is an incline that slopes such that it approaches the tip portion 44 as it extends from the inner surface 73 toward the outer surface 74. The inclined portion 79 is provided at a virtual corner 77 formed where the inner surface 73 and the opposing surface 75 meet. The guide surface 79A is a surface that connects the inner surface 73 and the opposing surface 75. The opposing surface 75 overlaps with the surface 44A of the terminal 40, and its edge continues to the guide surface 79A. The inner surface 73 continues from the end of the guide surface 79A opposite to the end where it connects to the opposing surface 75, and extends in the up-down direction HT away from the opposing surface 75.

The guide structure 78 is formed on the first edge 71A and the third edge 71C. First, the guide structure 78 formed on the first edge 71A will be described. The inclined portion 79 is provided at the imaginary corner 77 where the inner surface 73 and the opposing surface 75 meet on the first edge 71A. The guide surface 79A of the inclined portion 79 connects the inner surface 73 and the opposing surface 75 of the first edge 71A. The opposing surface 75 of the first edge 71A, the guide surface 79A of the inclined portion 79, and the inner surface 73 of the first edge 71A are continuous. The solder 100 is adhered to the opposing surface 75 and the guide surface 79A. The solder 100 may be adhered not only to the opposing surface 75 of the first edge 71A and the guide surface 79A continuous with this opposing surface 75, but also to the inner surface 73 of the first edge 71A. Since the inner surface 73 and/or the opposing surface 75 are continuous with the guide surface 79A, they may be referred to as continuous surfaces 73 and 75. The continuous surfaces 73 and 75 form part of an outer shell of the connecting piece 70. The outer shell refers to the external surfaces excluding the guide surface 79A. For example, the outer shell refers to the inner surface 73, the outer surface 74, the opposing surface 75, and the upper surface 76.

The solder 100 adhered to the guide surface 79A of the first edge 71A curves smoothly and flares out towards the surface 44A. The flared solder 100 penetrates into the continuous area 46. In other words, it can be said that the solder 100 adhered to the guide surface 79A forms a fillet shape. Accordingly, the presence or absence of the solder 100 can be easily confirmed in the up-down direction HT when viewed from the surface during inspection.

Similarly, an inclined portion 79 is provided at an imaginary corner portion 77 where the inner surface 73 and the opposing surface 75 of the third edge 71C meet. The guide surface 79A of the inclined portion 79 connects the inner surface 73 of the third edge 71C with the opposing surface 75 of the third edge 71C. The opposing surface 75 of the third edge 71C, the guide surface 79A of the inclined portion 79, and the inner surface 73 of the third edge 71C are continuous. Then, the solder 100 is adhered to the opposing surface 75 and the guide surface 79A that continues from the opposing surface 75. The solder 100 may be adhered not only to the opposing surface 75 of the third edge 71C and the guide surface 79A that continues from the opposing surface 75, but also to the inner surface 73 of the third edge 71C.

It should be noted that in the third edge 71C, the inner surface 73 and/or the opposing surface 75 may be referred to as continuous surfaces 73, 75, as they are surfaces continuous with the guide surface 79A. The continuous surfaces 73, 75 form an outer shell of the connecting piece 70. The solder 100 adhered to the guide surface 79A of the third edge 71C curves smoothly in a flared manner toward the surface 44A. The flared solder 100 penetrates into the continuous area 46. In other words, it can be said that the solder 100 adhered to the guide surface 79A forms a fillet shape. Accordingly, the presence or absence of the solder 100 can be easily confirmed in the up-down direction HT when viewed from the surface during inspection.

Additionally, the busbar module 10 further includes a metal film 81 to improve wettability of the solder 100. An example of the metal film 81 is plating. The metal film 81 is provided on the four edges 71 of the connecting piece 70. The metal film 81 is provided on the opposing surface 75, the top surface 76, and the guide surface 79A of the four edges 71. It should be noted that the metal film 81 may not be provided on the guide surface 79A.

Generally, a busbar is formed by punching a metal plate, such as copper, with a metal film like plating already provided on its surface in the plate thickness direction. Therefore, in the fracture surfaces that are perpendicular to the plate thickness direction, the base material, such as copper, which is not covered by the metal film, is exposed. Generally, it is known that fracture surfaces have inferior solder wettability compared to surfaces with a metal film. Therefore, even if you want to apply solder to the fracture surface, there is a concern that the solder will not easily spread over the fracture surface, making it difficult to apply solder over a wide area.

As a result, it is difficult to increase an adhesion area between the busbar and the solder on the fracture surface, making it challenging to enhance solder connection strength between the busbar and an object to which the busbar is fixed. Therefore, in order to improve the solder wettability on the fracture surface, it is considered to apply a new metal film to the fracture surface after forming the busbar. However, in such a case, there are concerns that additional material costs will be incurred due to the need for a new metal film for the fracture surface, and that additional processes will be required to apply the metal film to the fracture surface.

In the present embodiment, during a manufacturing process, the corner portion 77 connecting the opposing surface 75 and the inner surface 73 of the busbar 80 is flattened to form the inclined portion 79 as the guide structure 78. The process of flattening the corner portion 77 to form the inclined portion 79 as the guide structure 78 is also referred to as chamfering. According to this, the guide surface 79A derived from the opposing surface 75 is formed on at least a part of the inclined portion 79. Therefore, a metal film can be provided on at least a part of the guide surface 79A. According to this, the wettability and spreadability (ease of spreading) of the solder 100 on the guide surface 79A can be improved. An amount of the solder 100 adhering to the connecting piece 70 can be increased.

It should be noted that while examples of the connecting piece 70 having a frame shape have been described so far, the form of the connecting piece 70 is not limited to a frame shape. The connecting piece 70 may have a plate shape with the space 72 being closed. In that case, the connecting piece 70 has an opposing surface 75, an upper surface 76, and an outer surface 74. In that case, the inclined portion 79 is provided at the imaginary corner 77 where the opposing surface 75 and the outer surface 74 of the connecting piece 70 meet. The solder 100 adheres to the opposing surface 75 and the guide surface 79A. In this case, the solder 100 may also further adhere to the outer surface 74. The amount of solder 100 adhering to the connecting piece 70 can be increased.

### <Operational Effects>

The busbar module 10 of the present embodiment includes the substrate 50, the busbar 80, and solder 100. The substrate 50 has the base 30 and the terminals 40 extending from the base 30 toward the electrode terminals 24 and 25 of the battery cells 20. The busbar 80 includes the busbar main body 60 that is connected to the electrode terminals 24 and 25, and the connecting piece 70 that extends from the busbar main body 60 to connect to the terminal 40. The terminal 40 and the connecting piece 70 overlap in the up-down direction HT of the battery cell 20, and the connecting piece 70 and the terminal 40 are fixed by the solder 100. It should be noted that the substrate 50 may or may not have the terminal 40. The substrate 50 may have only the base 30. In that case, the connecting piece 70 and the base 30 are fixed by the solder 100.

The connecting piece 70 is formed with the guide structure 78 that has the guide surface 79A for guiding the solder 100. The solder 100 forms a part of the outer shell of the connecting piece 70 and adheres to the continuous surfaces 73 and 75, which are continuous with the guide surface 79A, as well as to the guide surface 79A. The adhesion amount between the solder 100 and the connecting piece 70 is increased because the continuous surfaces 73 and 75 and the guide surface 79A adhere to the solder 100. As a result, fixation between the terminal 40 and the connecting piece 70 is strengthened. For example, even if the battery cell 20 expands and contracts, causing stress on the solder 100, a connection between the terminal 40 and the connecting piece 70 is easily maintained.

The electrode terminals 24 and 25 are passed through the through holes 61 of the busbar 80 when the battery pack 1 is manufactured. After that, the nuts 130 are passed onto the electrode terminals 24 and 25, and by rotating the nuts 130 around the electrode terminals 24 and 25, the busbar 80 and the electrode terminals 24 and 25 are fixed. However, at this time, torque generated by the rotation of the nut 130 may apply stress to the solder 100 connecting the terminal 40 and the connecting piece 70.

Additionally, the battery cells 20 applied to the battery pack 1 individually expand and contract in the thickness direction TD in response to changes in an external environment. At this time, a relative position between the terminal 40 and the connecting piece 70 may shift. As a result, stress may be applied to the solder 100 connecting the terminal 40 and the connecting piece 70. In the present embodiment, as described above, the guide surface 79A and the continuous surfaces 73 and 75 are fixed with the solder 100, ensuring that the terminal 40 and the connecting piece 70 are securely fastened. Due to the unique structure of the battery pack 1, even if stress is applied to the solder 100, the connection between the terminal 40 and the connecting piece 70 is maintained according to the present embodiment.

The guide structure 78 has the inclined portion 79 where the guide surface 79A extends away from the surface 44A of the terminal 40, which is the solder connecting portion. The connecting piece 70 has the inner surface 73, the outer surface 74, the opposing surface 75, and the upper surface 76. The opposing surface 75, the guide surface 79A, and the inner surface 73 are continuous. The opposing surface 75 faces the surface 44A of the terminal 40 and its end continues to the guide surface 79A. The inner surface 73 continues from the end of the guide surface 79A opposite to the end where it connects to the opposing surface 75, and extends in the up-down direction HT away from the opposing surface 75. The solder 100 is adhered to the opposing surface 75 and the guide surface 79A.

Since the guide structure 78 has the inclined portion 79, the area of the guide surface 79A is larger than the projection area onto the surface 44A at the guide surface 79A. In the configuration where the guide structure 78 is provided at the imaginary corner 77 where the inner surface 73 and the opposing surface 75 meet, the amount of the solder 100 adhering tends to be greater compared to a configuration where the guide structure 78 is not provided. Therefore, even when stress is applied to the solder 100, a connection between the connecting piece 70 and the terminal 40 tends to become stronger, making it easier to maintain the connection between the two. Additionally, even when shear stress is applied to the solder 100 in the up-down direction HT, the connection between the connecting piece 70 and the terminal 40 is more likely to be maintained. Furthermore, since the guide structure 78 is the inclined portion 79, stress on the solder 100 due to thermal changes and the like is more easily alleviated.

The busbar module 10 has the metal film 81, such as plating, to improve the wettability and spread of the solder 100. The metal film 81 is provided on the guide surface 79A. According to this, the solder 100 easily spreads from the opposing surface 75 to the guide surface 79A. The amount of the solder 100 adhering to the guide surface 79A increases. Even if stress is applied to the solder 100, the connection between the connecting piece 70 and the terminal 40 is more likely to be maintained.

The connecting piece 70 has a frame shape forming an annular configuration around the up-down direction HT. The connecting piece 70 has the four edge 71 that form a frame. The space 72 is defined by the four edges 71. The guide structure 78 is provided on the inner side of the edge 71, which faces the space 72. The solder 100 is provided in the overlapping region 45 where the terminal 40 overlaps with the connecting piece 70, and in the continuous region 46 extending inward from the overlapping region 45 of the terminal 40. The solder 100 adhering to the guide surface 79A curves smoothly and flares outward towards the tip portion 44. The flared solder 100 penetrates into the continuous area 46. According to this, the solder 100 can be visually recognized in the up-down direction HT when viewed from the surface. During inspection, the presence or absence of the solder 100 can be easily confirmed in the up-down direction HT when viewed from the surface.

The connecting piece 70 has a roughly rectangular shape when viewed in the up-down direction HT. The connecting piece 70 has the four edge 71 that form a frame. As for the edges 71, the first edge 71A, the second edge 71B, the third edge 71C, and the fourth edge 71D are provided in this order in the clockwise direction. The guide structure 78 is formed on the first edge 71A and the third edge 71C, which are aligned in the width direction WD. The solder 100 is adhered to the guide surface 79A provided on the first edge 71A and the guide surface 79A provided on the third edge 71C. Accordingly, even if vibration occurs in a direction in which the guide structures 78 are aligned, an increased amount of the solder 100 adhesion makes it easier to maintain the connection between the terminal 40 and the connecting piece 70. As a result, misalignment between the terminal 40 and the connecting piece 70 can be reduced.

The substrate 50 is a flexible substrate. As mentioned above, the substrate 50 has the base 30 and the terminal 40. The terminal 40 has the first extension portion 41 and the second extension portion 42. The first extension portion 41 extends in the width direction WD from the end of the base 30 in the width direction WD toward each of the electrode terminals 24, 25. The second extension portion 42 is provided at an edge in the width direction WD at the end of the first extension portion 41 that is farther from the base 30. The second extension portion 42 extends away from the first extension portion 41 and toward the electrode surface 20A. The base 30, the first extension portion 41, and the second extension portion 42 are flexibly deformable. The base 30 and the first extension portion 41 are particularly flexible and deformable in the up-down direction HT. The second extension portion 42 is particularly flexible and deformable in both the up-down direction HT and the thickness direction TD.

The second extension portion 42 is stretched in the stacking direction when the battery cell 20 expands and contracts in the thickness direction TD. As described above, since the second extension portion 42 is flexibly deformable in both the up-down direction HT and the thickness direction TD, the second extension portion 42 is capable of following tension. Therefore, when the battery cell 20 expands and contracts in the thickness direction TD, stress is less likely to be applied to the solder 100. On the other hand, the second extension portion 42 may deform in a twisting manner due to the expansion and contraction or vibrations of the battery cell 20. In such cases, it is anticipated that significant stress may be applied to the solder 100. In contrast, in the present embodiment, the amount of the solder 100 adhered to the connecting piece 70 is increased. Even if significant stress is applied to the solder 100, the connection between the terminal 40 and the connecting piece 70 can be firmly maintained. This makes it less likely for stress to be applied to the solder 100. Even if the second extension portion 42 is pulled in the width direction WD, stress is less likely to be applied to the solder 100 because the guide structures 78 are provided on the two edges out of the four edges 71 that are aligned in the width direction WD.

### Second Embodiment

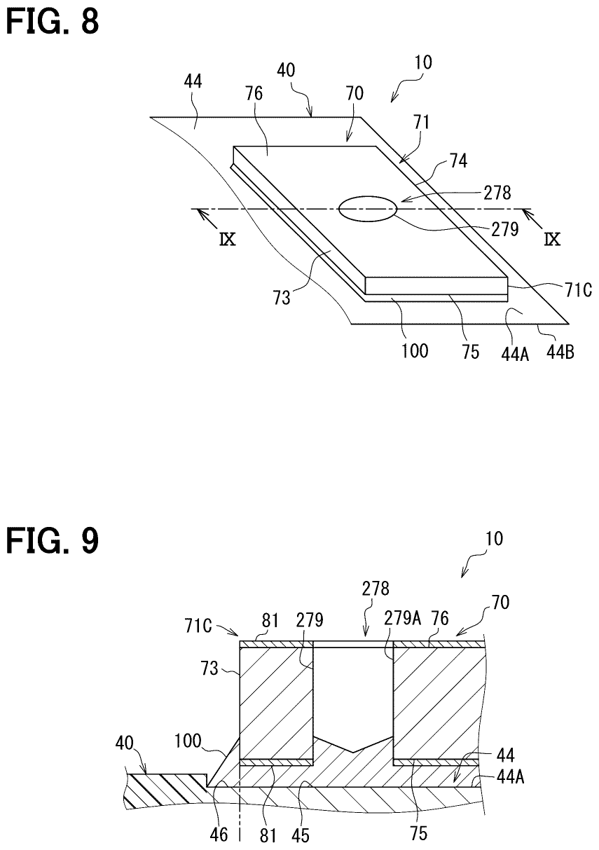

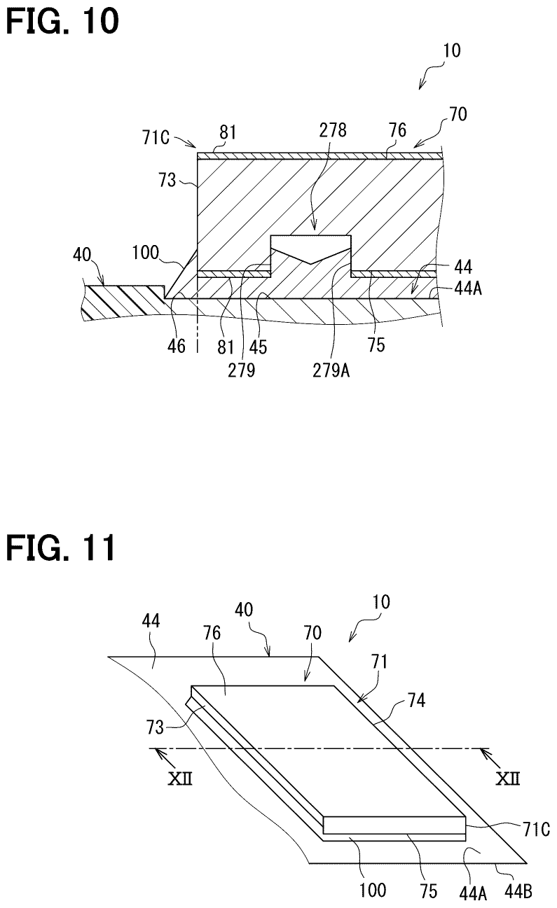

In the first embodiment, the configuration in which the guide structure 78 is the inclined portion 79 was described, but the guide structure 78 is not limited to the inclined portion 79. In a second embodiment, the guide structure 278 is a recess 279. In the second embodiment, other than an attachment form of the guide structure 278 and the solder 100, the other configurations are the same as those in the first embodiment. FIG. 8 is a schematic diagram illustrating the guide structure 278 of the second embodiment. FIG. 9 is a cross-sectional view taken along the line IX-IX shown in FIG. 8. FIG. 10 is a modification of the guide structure 278 of the second embodiment. FIGS. 8 to 10 show schematic diagrams and cross-sectional views illustrating the guide structure 278 provided on the third edge 71C. In FIG. 8, the second edge 71B and the fourth edge 71D, which are connected to the third edge 71C, are omitted, and only the third edge 71C is extracted and shown.

A recess 279, which is the guide structure 278 in the second embodiment, is a through hole that penetrates the upper surface 76 and the opposing surface 75. The recess 279 is defined by a guide surface 279A that connects the upper surface 76 and the opposing surface 75. The guide surface 279A is continuous with the opposing surface 75 and the upper surface 76. The solder 100 is provided between the connecting piece 70 and the terminal 40. The connecting piece 70 and the terminal 40 overlap in the up-down direction HT through the solder 100. The solder 100 has entered the recess 279. The solder 100 that has entered the recess 279 creeps up the guide surface 279A. The solder 100 adheres to the opposing surface 75, the guide surface 79A, and the inner surface 73.

The guide structure 278 provided on the third edge 71C will be described. The solder 100 adheres to the opposing surface 75 of the third edge 71C, the guide surface 279A of the recess 279 provided on the third edge 71C, and the inner surface 73 of the third edge 71C. In the second embodiment, the guide surface 279A and the continuous surfaces 73 and 75 are also fixed with the solder 100. The adhesive amount between the solder 100 and the connecting piece 70 increases. The fixation between the terminal 40 and the connecting piece 70 becomes more secure. Even when stress is applied to the solder 100, the connection between the terminal 40 and the connecting piece 70 is readily maintained. Furthermore, the recess 279 may be provided on the first edge 71A in addition to the third edge 71C. Additionally, the recess 279 may be provided on the plate-shaped connecting piece 70.

It should be noted that the recess 279 is not limited to a through hole penetrating the upper surface 76 and the opposing surface 75. The recess 279 may be a depression that is recessed from the opposing surface 75 toward the upper surface 76. In that case, the guide structure 278 has a guide surface 279A that defines the inner depression. The guide surface 279A is continuous with the opposing surface 75. The solder 100 is adhered to the opposing surface 75, the guide surface 279A, and the inner surface 73. This configuration also achieves the same effects. As another example, a through hole may be formed as a recess 279 in the first edge 71A, and a depression may be formed as a recess 279 in the third edge 71C. Additionally, the guide structure 278 of the second embodiment is not limited to being provided on only one edge 71. Guide structures 278 may be provided on a single edge 71. Additionally, the guide structure 278 only needs to be provided on the connecting piece 70.

### Third Embodiment

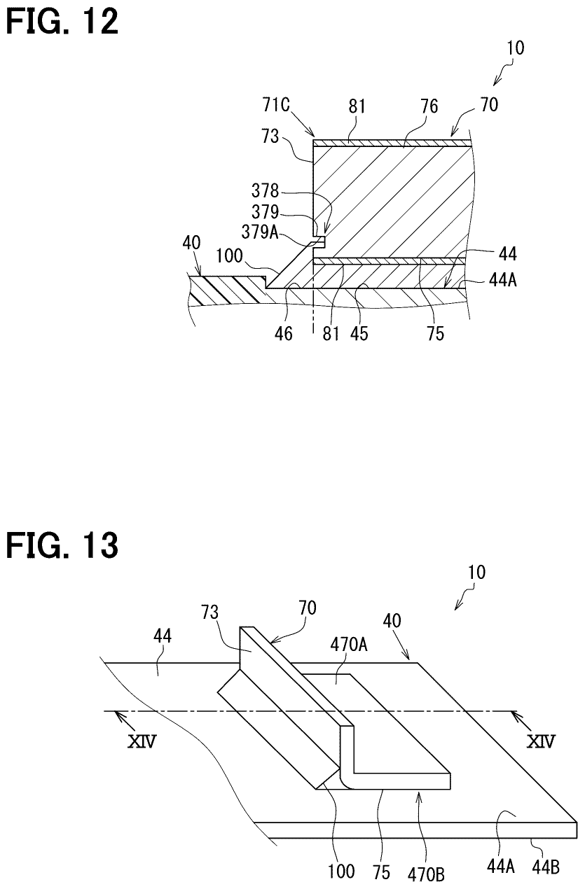

The guide structure 378 in a third embodiment is a recess 379. In the third embodiment, except for an attachment form of the guide structure 378 and the solder 100, the other configurations are the same as those in the first embodiment. FIG. 11 is a schematic diagram illustrating the guide structure 378 of the third embodiment. FIG. 12 is a cross-sectional view taken along the line XII-XII shown in FIG. 11. FIGS. 11 and 12 respectively show a schematic diagram and a cross-sectional view representing the guide structure 378 provided on the third edge 71C. In FIG. 11, the second edge 71B and the fourth edge 71D, which are connected to the third edge 71C, are omitted, and only the third edge 71C is extracted and shown.

In the third embodiment, the recess 379 that is recessed from the inner surface 73 toward the outer surface 74 is provided on the connecting piece 70 as the guide structure 378. The recess 379 is defined by a guide surface 379A that is continuous with the inner surface 73. The guide surface 379A is continuous with the inner surface 73. The solder 100 is provided between the connecting piece 70 and the terminal 40. The connecting piece 70 and the terminal 40 overlap in the up-down direction HT through the solder 100. The solder 100 creeps up the inner surface 73 and enters the recess 379. The solder 100 that has entered the recess 379 is attached to the guide surface 379A. The solder 100 adheres to the opposing surface 75, the guide surface 79A, and the inner surface 73.

The guide structure 378 provided on the third edge 71C will be explained. The solder 100 adheres to the opposing surface 75 of the third edge 71C, the guide surface 379A of the guide structure 378 provided on the third edge 71C, and the inner surface 73 of the third edge 71C. In the third embodiment, the guide surface 379A and the continuous surfaces 73 and 75 are also fixed with the solder 100. The amount of adhesion between the solder 100 and the connecting piece 70 increases. The fixation between the terminal 40 and the connecting piece 70 becomes more secure. Even if the battery cell 20 expands and contracts, applying stress to the solder 100, the connection between the terminal 40 and the connecting piece 70 is likely to be maintained. The recess 379 may be provided on the first edge 71A in addition to the third edge 71C. Furthermore, the recess 379 may be provided on the plate-shaped connecting piece 70.

### Fourth Embodiment

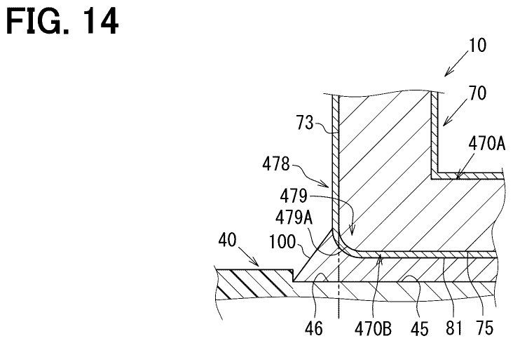

In a fourth embodiment, the guide structure 478 is a curved portion 479. FIG. 13 is a schematic diagram illustrating the guide structure 478 of the fourth embodiment. FIG. 14 is a cross-sectional view taken along line XIV-XIV in FIG. 13. In the fourth embodiment, the connecting piece 70 has, for example, a plate-like shape. The connecting piece 70 has an upper surface 470A and a lower surface 470B that are spaced apart in the plate thickness direction. A metal film 81 is provided on the upper surface 470A and the lower surface 470B. The connecting piece 70 is bent into a substantially L-shape so that a part of it rises from the terminal 40. The connecting piece 70 includes a curved surface in a bent portion so that it rises gently from the terminal 40.

A part of the connecting piece 70 extends along the terminal 40. The portion of the connecting piece 70 that extends along the terminal 40 overlaps with the terminal 40. The lower surface 470B of the portion of the connecting piece 70 that overlaps with the terminal 40 corresponds to the opposing surface 75. The remaining portion of the connecting piece 70 extends away from the terminal 40. The lower surface 470B of the portion of the connecting piece 70 that extends away from the terminal 40 corresponds to the inner surface 73.

A guide surface 479A that connects the lower surface 470B corresponding to the opposing surface 75 and the lower surface 470B corresponding to the side surface is provided at the bent portion. The guide surface 479A is a curved surface. The guide surface 479A is a part of the lower surface 470B. The solder 100 is provided between the connecting piece 70 and the terminal 40. The connecting piece 70 and the terminal 40 overlap in the up-down direction HT via the solder 100. The solder 100 climbs up from the lower surface 470B corresponding to the facing surface 75 to the lower surface 470B corresponding to the inner surface 73 via the guide surface 479A.

In the fourth embodiment, the connecting piece 70 and the terminal 40 are also fixed via the solder 100. The solder 100 adheres to the lower surface 470B corresponding to the facing surface 75, the guide surface 79A, and the lower surface 470B corresponding to the inner surface 73. The guide surface 79A and the continuous surfaces 73 and 75 are fixed with the solder 100. The adhesion amount between the solder 100 and the connecting piece 70 increases. As a result, the fixation between the terminal 40 and the connecting piece 70 becomes stronger. Even if the battery cell 20 expands and contracts, applying stress to the solder 100, the connection between the terminal 40 and the connecting piece 70 is likely to be maintained. According to the fourth embodiment, there is also the advantage that the metal film 81 is reliably provided on the guide surface 479A without additional cost or processes, improving the wetting and spreading of the solder 100.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A busbar module provided on electrode surfaces of battery cells stacked in a thickness direction, the busbar module comprising:
a substrate;
a busbar including a busbar main body connected to electrode terminals of the battery cells and a connecting piece extending from the busbar main body to overlap with the substrate and being connected to the substrate;
solder fixing the substrate and the connecting piece; and
a guide structure provided on the connecting piece and having a guide surface for guiding the solder, wherein
the solder adheres to the guide surface and at least a portion of a continuous surface forming an outer shell of the connecting piece and being continuous with the guide surface.

2. The busbar module according to claim 1, wherein
the guide structure has an inclined portion or a curved portion forming the guide surface which extends away from a portion where the solder is bonded to the substrate,
the continuous surface includes an opposing surface facing the substrate and having an edge continuous with the guide surface,
a lateral surface extending from an edge of the guide surface, which is opposite to an edge of the guide surface that is continuous with the opposing surface, away from the opposing surface, and
the solder adheres to at least the opposing surface and the guide surface.

3. The busbar module according to claim 2, further comprising:
a metal film for improving wetting spreading of the solder, wherein
the metal film is provided on at least a portion of the guide surface.

4. The busbar module according to claim 2, wherein
the connecting piece has edges forming an annular frame around an axis in an up-down direction of the battery cell,
the edges define a space surrounded by the edges,
the guide structure is provided on inner sides of the edges, which face the space,
the substrate has an overlapping region overlapping with the edges and a continuous region extending continuously from the overlapping region toward the space, and
a portion of the solder adhering to the guide surface spreads outward toward the continuous region.

5. The busbar module according to claim 4, wherein
the connecting piece has four edges defining the space, and
the guide structure is provided on two of the four edges aligned in a width direction of the battery cell.

6. The busbar module according to claim 5, wherein
the substrate is a flexible substrate,
the substrate includes a base overlapping the electrode surfaces and a terminal extending from the base toward the electrode surfaces,
the terminal includes:
a first extension portion extending from an end of the base in the width direction toward the electrode terminals; and
a second extension portion provided at an end of the first extension portion away from the base, extending toward the electrode surfaces, and having a tip connected to the connecting piece, and
the second extension portion is flexibly deformable in the up-down direction and the thickness direction.

7. The busbar module according to claim 6, wherein
the second extension portion includes:
a shaft portion extending in the up-down direction and being bent in mountain and valley shapes; and
a tip portion extending from a tip of the shaft portion away from the first extension portion in the thickness direction and connected to the connecting piece.

8. The busbar module according to claim 1, wherein
the guide structure is a recess having the guide surface inside,
the connecting piece includes an opposing surface facing the substrate,
the recess is provided in the connecting piece such that the guide surface is continuous with the opposing surface, and
the solder adheres to the opposing surface and the guide surface.

9. The busbar module according to claim 1, wherein
the guide structure is a recess having the guide surface inside,
the connecting piece includes an opposing surface facing the substrate and a lateral surface extending away from the opposing surface,
the recess is provided in the connecting piece such that the guide surface is continuous with the lateral surface, and
the solder adheres to the opposing surface, the lateral surface, and the guide surface.

10. A battery pack comprising:
battery cells stacked in a thickness direction;
a busbar module provided on electrode surfaces of the battery cells, wherein
the busbar module includes:
a substrate;
a busbar including a busbar main body connected to electrode terminals of the battery cells, and a connecting piece extending from the busbar main body to overlap with the substrate and being connected to the substrate;
solder fixing the substrate and the connecting piece; and
a guide structure provided on the connecting piece and having a guide surface for guiding the solder, and
the solder adheres to the guide surface and at least a portion of a continuous surface forming an outer shell of the connecting piece and being continuous with the guide surface.
